(19) United States
(12) Patent Application Publication
(10) Pub. No.: US 2026/0092200 A1
(43) Pub. Date: Apr. 2, 2026

(54) STARCH EXTRUDED FILM/ADHESIVE AND METHOD

(71) Applicant: Intertape Polymer Corp., Sarasota, FL (US)

(72) Inventors: John K. Tynan, JR., Port Huron, MI (US); Nathan I. Isser, North Street, MI (US); Janis Gunars Matisons, East China, MI (US)

(73) Assignee: Intertape Polymer Corp., Sarasota, FL (US)

(21) Appl. No.: 19/113,371

(22) PCT Filed: Sep. 20, 2023
(86) PCT No.: PCT/US2023/033243

§ 371 Date: Mar. 19, 2025

Related U.S. Application Data
(60) Provisional application No. 63/408,253, filed on Sep. 20, 2022.

(51) Int. Cl. C09J 7/21

(52) U.S. Cl. CPC C09J 7/21; C09J 2301/306; C09J 2400/283; C09J 2403/00; C09J 2429/00

(57) ABSTRACT

This disclosure is directed to a continuous, low-shear process for the compounding and starch. In one aspect of the disclosure, the starch may be applied directly as a web, film, or layer, for example, in a tape product.

### TECHNICAL FIELD

This disclosure is directed to a continuous, low-shear process for the compounding of starch and the production of films and/or adhesives and products therefrom. In one aspect of the disclosure, the starch may be applied directly as a sheet or film in a tape product.

### BACKGROUND

Conventional tapes and adhesives (and their combinations) as well as packaging materials such as air cushions, can be made or contain considerable amounts of polyolefins, the polyolefins being often petroleum-based polyolefins. With changing global trends facing most industries, due to environmental concerns regarding greenhouse gas emissions and high dependency on depleting petroleum-based resources, a strong sustainability strategy for creating better tapes and adhesives, for example, air cushions, tapes and their adhesives that are compostable, recyclable and/or repulpable is desired.

### SUMMARY

In one example, a tape is provided, the tape comprising: a repulpable backing having a first major surface and an opposing second major surface; a repulpable reinforcement adjacent the second major surface; and an adhesive layer adjacent the repulpable reinforcement. In one aspect, alone or in combination with any one of the previous aspects, the tape is at least 80, at least 85, or at least 90 weight percent hot water soluble or repulpable under pulping conditions, for example, the FBA Method discussed below.

In one aspect, the repulpable backing comprises essentially cellulose. In one aspect, alone or in combination with any one of the previous aspects, the repulpable backing is paper. In one aspect, alone or in combination with any one of the previous aspects, the repulpable backing is Kraft paper.

In one aspect, alone or in combination with any one of the previous aspects, the repulpable reinforcement is directly adjacent to the repulpable backing. In one aspect, alone or in combination with any one of the previous aspects, the repulpable backing is extrusion laminated to the repulpable reinforcement. In one aspect, alone or in combination with any one of the previous aspects, the repulpable backing is adhesion laminated to the repulpable reinforcement. In one aspect, alone or in combination with any one of the previous aspects, the repulpable backing is adhesion laminated to the repulpable reinforcement without adhesive. In one aspect, alone or in combination with any one of the previous aspects, the repulpable backing is extrusion laminated to the repulpable reinforcement without an adhesive.

In one aspect, alone or in combination with any one of the previous aspects, the tape further comprising an optional paper layer positioned between the repulpable reinforcement and the adhesive. In one aspect, alone or in combination with any one of the previous aspects, the paper layer and the repulpable backing are the same or different.

In one aspect, alone or in combination with any one of the previous aspects, the repulpable reinforcement comprises an unmodified starch, a modified starch, a synthetic starch, a crosslinked starch, or mixture of two or more thereof. In one aspect, alone or in combination with any one of the previous aspects, the repulpable reinforcement is film, web, or scrim comprising an unmodified starch, a modified starch, a synthetic starch, a crosslinked starch, or mixture of two or more thereof. In one aspect, alone or in combination with any one of the previous aspects, the repulpable reinforcement is at least 90 weight percent hot water soluble, e.g., 115-140° F. (46-60° C.) or repulpable under pulping conditions.

In one aspect, alone or in combination with any one of the previous aspects, the repulpable reinforcement comprises an unmodified starch, a modified starch, a synthetic starch, or a crosslinked starch derived from cassava, corn, potato, sweet potato, sago, tapioca, sorghum, bean, bracken, lotus, Trapa japonica, wheat, rice, oat, arrowroot, dent, or pea.

In one aspect, alone or in combination with any one of the previous aspects, the repulpable reinforcement comprises an unmodified starch, a modified starch, a synthetic starch, or a crosslinked starch derived from glutinous rice, waxy potato starch, and waxy corn.

In one aspect, alone or in combination with any one of the previous aspects, the repulpable reinforcement is an extruded web, film, or layer. In one aspect, alone or in combination with any one of the previous aspects, the repulpable reinforcement comprises a starch, a modified starch, a synthetic starch, a thermoplastic starch, or a combination thereof.

In one aspect, alone or in combination with any one of the previous aspects, the repulpable reinforcement comprises a starch with a combined weight ratio of amylose to amylopectin between 10:90 and 90:10. In one aspect, alone or in combination with any one of the previous aspects, the repulpable reinforcement comprises a modified starch with a combined weight ratio of amylose to amylopectin between 40:60 to 0:100. In one aspect, alone or in combination with any one of the previous aspects, the repulpable reinforcement comprises a synthetic starch with a combined weight ratio of amylose to amylopectin between 40:60 to 0:100. In one aspect, alone or in combination with any one of the previous aspects, the repulpable reinforcement comprises a thermoplastic starch with a combined weight ratio of amylose to amylopectin between 40:60 to 0:100.

In one aspect, alone or in combination with any one of the previous aspects, the repulpable reinforcement comprises a blend of starches with a combined weight ratio of amylose to amylopectin between 40:60 to 0:100, wherein the blend of starches comprises an unmodified starch, a modified starch, a synthetic starch, a thermoplastic starch, or a combination thereof.

In one aspect, alone or in combination with any one of the previous aspects, the repulpable reinforcement comprises a blend of starches comprises a combination of a first starch having an amylose to amylopectin weight ratio between 40:60 to 0:100 and a second starch having an amylose to amylopectin weight ratio between 40:60 to 0:100, where at least one of the first starch and the second starch, independently, is unmodified, modified, synthetic, or crosslinked.

In one aspect, alone or in combination with any one of the previous aspects, the weight ratio of the starch to the water-soluble materials is between 50:1 to 1:50. In one aspect, alone or in combination with any one of the previous aspects, the one or more repulpable materials is polyvinyl alcohol or polyvinyl alcohol copolymer and salts thereof, polyethyleneimines, polyvinyl pyrrolidones, polyalkylene oxides, polyhydroxyalkanoates, polyacrylamides, cellulose ethers, cellulose esters, cellulose amides, polyvinyl acetates, polyamides, poly(meth)acrylic acid, poly(meth)acrylates and salts thereof, gelatines, methylcelluloses, carboxymethylcelluloses, micro-fibrillated celluloses, nano-fibrillated celluloses, and blends and/or salts thereof, ethylcelluloses, hydroxyethyl celluloses, hydroxypropyl methylcelluloses, natural and synthetic sugar alcohols, dextrins, maltodextrins, guar gum, gum Acacia, gum Arabic, xanthan gum, carrageenan, algin, Locust Bean, gellan, copolymers thereof, blends thereof, and combinations thereof.

In one aspect, alone or in combination with any one of the previous aspects, the repulpable reinforcement comprises starch or a modified starch in combination with polyvinyl alcohol or polyvinyl alcohol copolymer. In one aspect, alone or in combination with any one of the previous aspects, the repulpable reinforcement comprises starch or a modified starch in combination with polyvinyl alcohol having a saponification degree of 80 to 99.8 mol %.

In one aspect, alone or in combination with any one of the previous aspects, the repulpable reinforcement comprises starch or a modified starch in combination with polyvinyl alcohol copolymer comprising one or more anionic monomers.

In one aspect, alone or in combination with any one of the previous aspects, the one or more anionic monomer are independently selected from the group consisting of vinyl acetic acid, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, fumaric anhydride, itaconic acid, monomethyl itaconate, dimethyl itaconate, itaconic anhydride, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sulfoethyl acrylate, alkali metal salts of the foregoing, esters of the foregoing, and combinations thereof.

In one aspect, alone or in combination with any one of the previous aspects, the tape further comprises one or more components selected from the group consisting of plasticizers, plasticizer compatibilizers, lubricants, release agents, fillers, extenders, impact modifiers, cross-linking agents, antiblocking agents, antioxidants, detackifying agents, antifoams, nanoparticles, bleaching agents, surfactants, biocides, and combinations or reaction products thereof. In one example, fillers include microfibrillated cellulose, nanofibrillated cellulose, and mixtures thereof in any proportions.

In one aspect, alone or in combination with any one of the previous aspects, the adhesive layer is a water-activated adhesive. In one aspect, alone or in combination with any one of the previous aspects, the water-activated adhesive is directly adjacent the repulpable reinforcement.

In one aspect, alone or in combination with any one of the previous aspects, the tape further comprising a paper layer between the repulpable reinforcement and the adhesive. In one aspect, alone or in combination with any one of the previous aspects, the water-activated adhesive is directly adjacent the paper layer. In one aspect, alone or in combination with any one of the previous aspects, the paper layer and the repulpable backing are the same or different.

In one aspect, alone or in combination with any one of the previous aspects, the water-activated adhesive is a polyvinyl acetate emulsion adhesive, a poly ethylene vinyl acetate adhesive, a poly(meth)acrylic or poly(meth)acrylic emulsion adhesive, a starched-based adhesive or combinations or laminates thereof.

In one aspect, alone or in combination with any one of the previous aspects, the water-activated adhesive is a starched-based adhesive. In one aspect, alone or in combination with any one of the previous aspects, the water-activated adhesive is a starched-based adhesive in combination with an acrylamide-based adhesive or acrylic-based adhesive. In one aspect, alone or in combination with any one of the previous aspects, the water-activated adhesive comprises a filler.

In one aspect, alone or in combination with any one of the previous aspects, the adhesive layer is a pressure sensitive adhesive.

In one aspect, alone or in combination with any one of the previous aspects, the adhesive is foamed. In one aspect, alone or in combination with any one of the previous aspects, the tape is arranged in a roll.

In one example, a method for producing a tape is provided, the method comprising: continuously or semi-continuously mixing an amount of a starch and an added amount of a state of water with a repulpable material with heating in a low shear extruder or mixing device and obtaining a mixture; continuous or semi-continuously extruding the mixture; and cooling the mixture.

In one aspect, the method further comprises, prior to heating in the low shear extruder, a preconditioning of the starch.

In one aspect, the method further comprises continuously producing a film from the mixture and contacting the film to the second major surface of the repulpable backing.

In one aspect, alone or in combination with any one of the previous aspects, the high solids continuously or semi-continuously mixing is of a high solids content of the starch, where the high solids includes from 25 weight percent to 75 weigh percent of the starch. In one aspect, alone or in combination with any one of the previous aspects, the method further comprises applying an adhesive composition adjacent the repulpable reinforcement.

In one aspect, alone or in combination with any one of the previous aspects, the method further comprising applying an adhesive composition directly adjacent the repulpable reinforcement.

In one aspect, alone or in combination with any one of the previous aspects, the method further comprising foaming the adhesive. In one aspect, alone or in combination with any one of the previous aspects, the method further comprising forming pellets from the mixture.

In one aspect, alone or in combination with any one of the previous aspects, the method further comprising remelting the pellets to a melt, producing a film from the melt, and extrusion laminating the film to the second major surface of the repulpable backing.

In one aspect, alone or in combination with any one of the previous aspects, the method further comprises remelting the pellets to a melt, producing a film from the melt, extrusion laminating the film to the second major surface of the repulpable backing, and applying an adhesive composition adjacent the repulpable reinforcement.

In one aspect, alone or in combination with any one of the previous aspects, the total amount of the state of water added is 10 to 50% by mass of the mixture. In one aspect, alone or in combination with any one of the previous aspects, the state of water is liquid, steam, or a combination of liquid and steam.

In one aspect, alone or in combination with any one of the previous aspects, during the mixing, the heating is performed at a temperature less than 200° C., or less than 210° C.

In one aspect, alone or in combination with any one of the previous aspects, the contacting the film to the second major surface of the repulpable backing is continuous. In one aspect, alone or in combination with any one of the previous aspects, the mixture is extruded as a continuous web, film, or layer. In one aspect, alone or in combination with any one of the previous aspects, the melt is extruded using a spinneret die, slot-die, annular die, co-extruded die or combinations thereof.

In one aspect, alone or in combination with any one of the previous aspects, the melt, before or after cooling, is adhesion laminated to the repulpable backing. In one aspect, alone or in combination with any one of the previous aspects, the adhesive composition is applied as a continuous web, sheet, or layer to the repulpable reinforcement. In one aspect, alone or in combination with any one of the previous aspects, the adhesive composition is applied to the repulpable reinforcement using a spinneret die, slot-die coater, curtain coater, rotor damper coater, reverse roll, roll-over-roll coating and knife-over-roll coating. In one aspect, alone or in combination with any one of the previous aspects, the adhesive composition is applied randomly or in a pattern.

In one aspect, alone or in combination with any one of the previous aspects, the method further comprises adding secondary materials to the mixture. In one aspect, alone or in combination with any one of the previous aspects, the secondary materials comprise solid raw materials selected from the group consisting of impact modifiers, tackifying resins, extenders, activators, crosslinkers, colorants, recycled waste plastic, recycled cellulosic material, microfibrillated cellulose, nanofibrillated cellulose, clays, for example, bentonite, and mixtures thereof in any proportions. In one aspect, alone or in combination with any one of the previous aspects, the secondary materials comprise recycled material. In one aspect, alone or in combination with any one of the previous aspects, the secondary materials further comprise an activator selected from the group consisting of zinc oxide, azide, epoxide, sodium tetraborate, magnesium oxide and combinations thereof and an extender selected from the group consisting of clays, calcium carbonate, talc, aluminum hydrates and combinations thereof.

In one aspect, alone or in combination with any one of the previous aspects, the repulpable backing is paper. In one aspect, alone or in combination with any one of the previous aspects, the repulpable backing is Kraft paper.

In one aspect, alone or in combination with any one of the previous aspects, the repulpable backing is adhesion laminated to the repulpable reinforcement. In one aspect, alone or in combination with any one of the previous aspects, the repulpable backing is extrusion laminated to the repulpable reinforcement. In one aspect, alone or in combination with any one of the previous aspects, the repulpable backing is extrusion laminated to the repulpable reinforcement without an adhesive.

In one aspect, alone or in combination with any one of the previous aspects, the repulpable reinforcement, after cooling, is at least 90 weight percent hot water soluble or repulpable under pulping conditions.

In one aspect, alone or in combination with any one of the previous aspects, the repulpable reinforcement comprises a modified or synthetic starch. In one aspect, alone or in combination with any one of the previous aspects, the modified starch is wherein the modified starch is epoxidized, alkylated, carboxylated, carboxymethylated, alkylacetylated, alkaline-modified, acid-modified, bleached, oxidized, enzyme-treated, phosphorylated, phosphated, hydroxy alkylated, borax-treated, urea treated, urea-formaldehyde treated, resorcinol-formaldehyde treated, thermally treated, dry heated, or enzyme treated, or dextrinized.

In one aspect, alone or in combination with any one of the previous aspects, the modified starch is a thermoplastic starch.

In one aspect, alone or in combination with any one of the previous aspects, the repulpable reinforcement comprises starch derived from cassava, corn, potato, sweet potato, sago, tapioca, sorghum, bean, bracken, lotus, Trapa japonica, wheat, rice, oat, arrowroot, dent or pea. In one aspect, alone or in combination with any one of the previous aspects, the repulpable reinforcement comprises glutinous rice, waxy potato starch, and waxy corn.

In one aspect, alone or in combination with any one of the previous aspects, the starch comprises a blend of starches with a combined weight ratio of amylose to amylopectin between 40:60 and 0:100. In one aspect, alone or in combination with any one of the previous aspects, the starch comprises a modified starch with a combined weight ratio of amylose to amylopectin between 40:60 to 0:100. In one aspect, alone or in combination with any one of the previous aspects, the starch is a blend of modified starches with a combined weight ratio of amylose to amylopectin between 40:60 and 0:100. In one aspect, alone or in combination with any one of the previous aspects, the starch comprises a combination of a first starch having an amylose to amylopectin weight ratio between 40:60 and 0:100 and a second starch having an amylose to amylopectin weight ratio between 40:60 and 0:100, where at least one of the first starch and the second starch, independently, is unmodified, modified, synthetic, or crosslinked.

In one aspect, alone or in combination with any one of the previous aspects, the repulpable reinforcement comprises starch or a modified starch in combination with one or more repulpable materials. In one aspect, alone or in combination with any one of the previous aspects, the water in the film, after drying, is between 2-25 weight percent.

In one aspect, alone or in combination with any one of the previous aspects, the weight ratio of the starch to the water-soluble materials is between 50:1 to 1:50.

In one aspect, alone or in combination with any one of the previous aspects, the repulpable material is polyvinyl alcohol or polyvinyl alcohol copolymer and salts thereof, polyethyleneimines, polyvinyl pyrrolidones, polyalkylene oxides, polyhydroxyalkanoates, polyacrylamides, cellulose ethers, cellulose esters, cellulose amides, polyvinyl acetates, polyamides, gelatines, poly (meth)acrylic acid, poly(meth)acrylates and salts thereof, methylcelluloses, carboxymethylcelluloses and salts thereof, ethylcelluloses, hydroxyethyl celluloses, hydroxypropyl methylcelluloses, microfibrillated celluloses, modified microfibrillated celluloses, nanofibrillated celluloses, modified nanofibrillated celluloses, sugar alcohols, dextrins, maltodextrins, guar gum, gum Acacia, gum Arabic, xanthan gum, carrageenan, algin, Locust Bean, gellan copolymers thereof, blends thereof, and combinations thereof.

In one aspect, alone or in combination with any one of the previous aspects, the repulpable reinforcement comprises starch or a modified starch in combination with polyvinyl alcohol or polyvinyl alcohol copolymer. In one aspect, alone or in combination with any one of the previous aspects, the repulpable reinforcement comprises starch or a modified starch in combination with polyvinyl alcohol and a polyvinyl alcohol copolymer. In one aspect, alone or in combination with any one of the previous aspects, the repulpable reinforcement comprises starch and a modified starch in combination with polyvinyl alcohol and a polyvinyl alcohol copolymer. In one aspect, alone or in combination with any one of the previous aspects, the repulpable reinforcement comprises starch or a modified starch in combination with polyvinyl alcohol or polyvinyl alcohol copolymer having a saponification degree of 80 to 99.8 mol %.

In one aspect, alone or in combination with any one of the previous aspects, the repulpable reinforcement comprises starch and/or a modified starch in combination with polyvinyl alcohol and/or polyvinyl alcohol copolymer comprising one or more anionic monomers. In one aspect, alone or in combination with any one of the previous aspects, the one or more anionic monomer are independently selected from the group consisting of vinyl acetic acid, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, fumaric anhydride, itaconic acid, monomethyl itaconate, dimethyl itaconate, itaconic anhydride, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sulfoethyl acrylate, alkali metal salts of the foregoing, esters of the foregoing, and combinations thereof.

In one aspect, alone or in combination with any one of the previous aspects, the method further comprises including one or more components selected from the group consisting of impact modifiers, plasticizers, plasticizer compatibilizers, lubricants, release agents, fillers, microfibrillated celluloses, modified microfibrillated celluloses, nanofibrillated celluloses, modified nanofibrillated celluloses, sugar alcohols, dextrins, maltodextrins, clays, biocides, humectants, extenders, cross-linking agents, antiblocking agents, antioxidants, detackifying agents, antifoams, nanoparticles, bleaching agents, surfactants, and combinations or reaction products thereof.

In one aspect, alone or in combination with any one of the previous aspects, the adhesive layer is a water-activated adhesive. In one aspect, alone or in combination with any one of the previous aspects, the method further comprising introducing an optional repulpable layer between the repulpable reinforcement and the adhesive. In one aspect, alone or in combination with any one of the previous aspects, the water-activated adhesive is directly adjacent the repulpable reinforcement. In one aspect, alone or in combination with any one of the previous aspects, the paper layer and the repulpable backing are the same or different.

In one aspect, alone or in combination with any one of the previous aspects, the water-activated adhesive is a polyvinyl acetate emulsion adhesive, a poly ethylene vinyl acetate adhesive, a polyacrylic or poly (meth)acrylic emulsion adhesive, a starched-based adhesive or combinations or laminates thereof.

In one aspect, alone or in combination with any one of the previous aspects, the water-activated adhesive is a starched-based adhesive. In one aspect, alone or in combination with any one of the previous aspects, the adhesive layer is a pressure sensitive adhesive.

In one aspect, alone or in combination with any one of the previous aspects, the water-activated adhesive comprises a filler. In one aspect, alone or in combination with any one of the previous aspects, the adhesive is foamed.

In one aspect, alone or in combination with any one of the previous aspects, the average molecular weight of the starch is reduced less than 50% as measured by GPC or viscosity. In one aspect, alone or in combination with any one of the previous aspects, the average molecular weight of the starch is reduced less than 20% as measured by GPC. In one aspect, alone or in combination with any one of the previous aspects, the average molecular weight of the starch is reduced less than 10% as measured by GPC.

In one aspect, alone or in combination with any one of the previous aspects, the method further comprises crosslinking the adhesive composition. In one aspect, alone or in combination with any one of the previous aspects, crosslinking the adhesive composition uses a process selected from the group consisting of EB crosslinking, UV crosslinking, thermal and/or chemical crosslinking and combinations thereof.

In one aspect, alone or in combination with any one of the previous aspects, the method further comprising contacting the film of the composition to a paper backing. In one aspect, alone or in combination with any one of the previous aspects, the method further comprising applying an adhesive to the film of the composition. In one aspect, alone or in combination with any one of the previous aspects, the method further comprising introducing an optional repulpable layer to the film of the composition. In one aspect, alone or in combination with any one of the previous aspects, the method further comprising applying an adhesive to the paper layer.

In another example, a film is provided, the film comprising: a starch; and an amount of repulpable material.

In one aspect, the starch film is at least 90 weight percent hot water soluble or repulpable under pulping conditions, for example, the FBA Method. In one aspect, alone or in combination with any one of the previous aspects, the starch present in the film is an alkyl etherized starch, carboxyalkyl etherized starch, hydroxyalkyl etherized starch having a hydroxyalkyl group having 2 to 6 carbon atoms, and synthetic starches. In one aspect, alone or in combination with any one of the previous aspects, the starch present in the film is a thermoplastic starch.

In one aspect, alone or in combination with any one of the previous aspects, the starch present in the film is derived from cassava, corn, potato, sweet potato, sago, tapioca, sorghum, bean, bracken, lotus, Trapa japonica, wheat, rice, oat, arrowroot, dent, or pea. In one aspect, alone or in combination with any one of the previous aspects, the starch present in the film is glutinous rice, waxy potato starch, and waxy corn.

In one aspect, alone or in combination with any one of the previous aspects, the starch comprises an amylose to amylopectin weight ratio between 10:90 and 90:10. In one aspect, alone or in combination with any one of the previous aspects, the starch comprises a blend of starches with a combined weight ratio of amylose to amylopectin between 10:90 and 90:10.

In one aspect, alone or in combination with any one of the previous aspects, the starch comprises a modified starch with a combined weight ratio of amylose to amylopectin between 40:60 to 0:100. In one aspect, alone or in combination with any one of the previous aspects, the starch is a blend of modified starches with a combined weight ratio of amylose to amylopectin between 40:60 to 0:100. In one aspect, alone or in combination with any one of the previous aspects, the starch comprises a combination of a first starch having an amylose to amylopectin weight ratio between 40:60 to 0:100and a second starch having an amylose to amylopectin weight ratio between 40:60 to 0:100, where at least one of the first starch and the second starch, independently, is unmodified, modified, synthetic, or crosslinked.

In one aspect, alone or in combination with any one of the previous aspects, the repulpable material is polyvinyl alcohol or polyvinyl alcohol copolymer and salts thereof, polyethyleneimines, polyvinyl pyrrolidones, polyalkylene oxides, polyhydroxyalkanoates, polyacrylamides, cellulose ethers, cellulose esters, cellulose amides, polyvinyl acetates, polyamides, gelatines, poly (meth)acrylic acid, poly(meth)acrylates and salts thereof, methylcelluloses, carboxymethylcelluloses and salts thereof, ethylcelluloses, hydroxyethyl celluloses, hydroxypropyl methylcelluloses, microfibrillated celluloses, modified microfibrillated celluloses, nanofibrillated celluloses, modified nanofibrillated celluloses, sugar alcohols, dextrins, maltodextrins, clays, biocides, humectants, dextrins, maltodextrins, guar gum, gum Acacia, xanthan gum, carrageenan, copolymers thereof, blends thereof, and combinations thereof.

In one aspect, alone or in combination with any one of the previous aspects, the repulpable material is polyvinyl alcohol or polyvinyl alcohol copolymer. In one aspect, alone or in combination with any one of the previous aspects, the repulpable material is polyvinyl alcohol in combination with a polyvinyl alcohol copolymer. In one aspect, alone or in combination with any one of the previous aspects, the polyvinyl alcohol has a saponification degree of 80 to 99.8 mol %.

In one aspect, alone or in combination with any one of the previous aspects, the polyvinyl alcohol copolymer comprises one or more anionic monomers. In one aspect, alone or in combination with any one of the previous aspects, the one or more anionic monomer are independently selected from the group consisting of vinyl acetic acid, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, fumaric anhydride, itaconic acid, monomethyl itaconate, dimethyl itaconate, itaconic anhydride, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sulfoethyl acrylate, alkali metal salts of the foregoing, esters of the foregoing, and combinations thereof.

In one aspect, alone or in combination with any one of the previous aspects, the film further comprises one or more components selected from the group consisting of impact modifiers, plasticizers, plasticizer compatibilizers, lubricants, release agents, fillers, microfibrillated celluloses, modified microfibrillated celluloses, nanofibrillated celluloses, modified nanofibrillated celluloses, sugar alcohols, dextrins, maltodextrins, clays, biocides, humectants, extenders, cross-linking agents, antiblocking agents, antioxidants, detackifying agents, antifoams, nanoparticles, bleaching agents, surfactants, and combinations or reaction products thereof.

In one aspect, alone or in combination with any one of the previous aspects, the weight ratio of the starch to the repulpable material is between 50:1 to 1:50.

In another example, a process for producing a starch film composition is provided, the process comprising: continuously or semi-continuously metering into low shear extrusion equipment, for example, a planetary roller extruder, a starch film composition comprising a starch, modified starch, thermoplastic starch, or combination, a state of water, and a repulpable material; continuously mixing the composition in a compounding section of the low shear extrusion equipment; and continuously discharging a starch film from the extruder.

In one aspect, the compounding sections comprises a plurality of roller barrel sections. In one aspect, alone or in combination with any one of the previous aspects, each roller barrel section comprises a plurality of mixing spindles.

In one aspect, alone or in combination with any one of the previous aspects, the process further comprising adding the state of water to the composition in the compounding section. In one aspect, alone or in combination with any one of the previous aspects, the state of water is liquid, steam, or a combination of liquid and steam. In one example, the starch is preconditioned.

In one aspect, alone or in combination with any one of the previous aspects, the process further comprising adding secondary raw materials to the compounding section. In one aspect, alone or in combination with any one of the previous aspects, the secondary raw materials comprise solid, liquid or gaseous materials. In one aspect, alone or in combination with any one of the previous aspects, the solid materials are selected from the group consisting of thermoplastic elastomers, resins, extenders, activators, anti-degradants, biocides, humectants, blowing agents, crosslinkers and mixtures thereof.

In one aspect, alone or in combination with any one of the previous aspects, the compounding section further comprises a dosing unit and the solid materials are added to the compounding section via the dosing unit.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIG. 1A is a perspective view of a roll of tape for one embodiment of the disclosure;

FIG. 1B is an enlarged cross-sectional view of the tape of FIG. 1A, illustrating the layers thereof along line 2-2 of FIG. 1A;

FIG. 2A is a perspective view of a roll of tape for one embodiment of the disclosure;

FIG. 2B is an enlarged cross-sectional view of the tape of FIG. 2A, illustrating the layers thereof along line 3-3 of FIG. 2A;

FIG. 3A is a perspective view of a roll of tape for one embodiment of the disclosure.

FIG. 3B is an enlarged cross-sectional view of the tape of FIG. 3A, illustrating the layers thereof along line 4-4 of FIG. 3A;

FIG. 4 is a longitudinal sectional view of a low shear extrusion equipment in accordance with one aspect of the present disclosure ;.

FIG. 5 is an enlarged view of an exemplary double transversal mixing spindle;

FIG. 6 is a cross-sectional view of a dosing ring from the low shear extrusion equipment in FIG. 4;

FIG. 7 is cross-sectional view of a slot die coater;

FIG. 8 is a longitudinal sectional view of an exemplary low shear extrusion equipment and slot die coater in accordance with one aspect of the present invention; and

FIG. 9 is a cross-sectional view of the exemplary low shear extrusion equipment in FIG. 1 along line 6-6.

### DETAILED DESCRIPTION

The present disclosure provides for the compounding and/or extrusion of starch containing films.

In one aspect, the present disclosure provides for the compounding and/or extrusion of starch with or without essentially no amylose. In one aspect, the present disclosure provides for compounding and/or extrusion of starch that is less than 40 weight percent amylose, less than 30 weight percent amylose, less than 20 weight percent amylose, less than 10 weight percent amylose, less than 9 weight percent amylose, less than 8 weight percent amylose, less than 7 weight percent amylose, less than 6 weight percent amylose, less than 5 weight percent amylose, less than 4 weight percent amylose, less than 3 weight percent amylose, less than 2 weight percent amylose, less than 1 weight percent amylose (essentially all amylopectin).

In one aspect, the present disclosure provides for compounding and/or extrusion of high amylopectin content, alone or with other adjuvants, processed in such a way to substantially preserve molecular weight and branching of the amylopectin. Compounding/extrusion applications of such starch materials can be applied to packaging applications, for example, providing tenacious films capable of reinforcing water activated tapes (WATs) tape as well as providing films for use as stretch film, shrink film, duct tape backing, polyolefin tapes, air pillows/cushions, bubble wrap for use on its own or in mailers. Additionally, compounding/extrusion applications of such starch materials and the preparation of film or sheet are amenable to sachet's, such as those currently used for condiments, health/hygiene, and detergent pods. In addition, compounding/extrusion applications of such starch materials are employable to address water sensitivity requirements for certain applications by balancing of amylose/amylopectin ratios and/or coupled with control of molecular weight changes and/or branching of the starch during compounding and/or extrusion.

Such starch film/sheet as disclosed herein are useful in providing substrates for receiving CVD/PVD SiOx and/or AlOx coatings with improved air/water barrier properties Such starch materials as disclosed herein are configured to receive paint or varnishes. Such starch film/sheet as disclosed herein can comprise plasticizers, fillers, other polymers, biocides, humectants, UV stabilizers, and the like.

In one example, compositions of starch produced using low shear extrusion equipment and products made therefrom are provided. Such products provide for sustainable or recyclable, and/or repulpable products that can be used alone or in combination with packaging that is also sustainable or recyclable, and/or repulpable.

As used herein, the phrase “water activated adhesive” is inclusive of adhesives that are generally non-adhesive dry and become adhesive upon exposure to an aqueous medium where the aqueous medium comprises water and optionally other solvents such as alcohols.

As used herein, the phrase “state of water” is inclusive of water in a solid, liquid, or gaseous and/or steam state. The state of water can comprise additional solvents such as alcohols and other unintentional impurities.

As used herein, “starch” and “starch comprising” is inclusive of any synthetic or botanic starch, or blends thereof, and combinations, blends, or grafts with one or more polymers. As used herein, “botanical starch” is starch isolated, derived, and or purified from any botanical source by any means. In one example, the botanical starch is derived or obtained from, but not limited to, cassava, corn, sorghum, wheat, sago, tapioca, legumes, barley, rice, dent, pea, and/or potatoes. Other sources of botanical and non-botanical starch can be employed.

As used herein, synthetic starch is inclusive of “modified botanical starch” e.g., any botanical starch that is modified chemically, genetically, enzymatically, mechanically and/or thermally. As used herein, synthetic starch is also inclusive of non-botanical starch, e.g., starch prepared from carbon dioxide.

As used herein “modified starch” is inclusive of starch that is epoxidized, alkylated, carboxylated, carboxymethylated, alkylacetylated, alkaline-modified, bleached, oxidized, enzyme-treated, phosphorylated, phosphated, hydroxy alkylated, borax-treated, urea treated, urea-formaldehyde treated, resorcinol-formaldehyde treated, thermally treated, dry heated, acid or enzyme-thinned, or dextrinized.

As used herein, the term “repulpable” is inclusive of the 2013 Fibre Box Association Voluntary Standard for Repulping and Recycling Corrugated Fiberboard Treated to Improve Its Performance in the Presence of Water and Water Vapor (“FBA method”).

As used herein “repulpable materials” are inclusive of is polyvinyl alcohol or polyvinyl alcohol copolymer and salts thereof, polyethyleneimines, polyvinyl pyrrolidones, polyalkylene oxides, polyhydroxyalkanoates, polyacrylamides, cellulose ethers, cellulose esters, cellulose amides, polyvinyl acetates, polyamides, poly(meth)acrylic acid, poly(meth)acrylates and salts thereof, gelatines, methylcelluloses, carboxymethylcelluloses and salts thereof, ethylcelluloses, hydroxyethyl celluloses, hydroxypropyl methylcelluloses, dextrins, maltodextrins, guar gum, gum Acacia, gum Arabic, xanthan gum, carrageenan, algin, Locust Bean, gellan copolymers thereof, blends thereof, carbohydrates, proteins, lipids, triglycerides, and phospholipids, alone or in combination with any of the above.

Low shear extrusion equipment includes, by way of non-limiting examples, planetary roller extruders (PRE), planetary roller mixers, twin-screw extruders configured with counter-or co-rotating, intermeshing or non-intermeshing screws, static mixing devices, and the like. PRE's have typically been used in processing of thermoplastics such as PVC, for example, where they were used primarily to supply downstream units such as, for example, cast or blown film devices, calenders or roll mills. Planetary roller extruders can be used to process heat-sensitive compounds with a minimum of degradation, for example, by facilitating thin layers of compound exposed to large surface areas, thereby resulting in effective heat exchange, mixing and temperature control. Planetary roller extruders are available in various designs and sizes. The diameters of the roll cylinders, depending on the desired throughput, are typically between 30 mm to 1000 mm, or 70 mm and 500 mm.

Planetary roller extruders generally have a filling section and a compounding section. The filling section typically includes a conveying screw to which certain raw materials are fed continuously. The conveying screw then passes the material to the compounding section. The compounding section includes a driven main spindle and a number of planetary spindles which rotate around the main spindle within a roll cylinder with internal helical gearing. The rotary speed of the main spindle and hence the rotational speed of the planetary spindles can be varied and is one parameter to be controlled during the compounding process. The materials are circulated between the main and planetary spindles, or between the planetary spindles and the helical gearing of the roll section, so that under the materials are dispersed to form a homogeneous composition.

The number of planetary spindles rotating in each roll cylinder can be varied and thus adapted to the requirements of the process. The number of spindles influences the free volume within the planetary roller extruder, the residence time of the material in the process, and also determines the surface area for heat and material exchange. By way of the dispersive energy introduced, the number, geometry and/or configuration of planetary spindles has an influence on the result of compounding. Given a constant diameter of roll cylinder, a larger number of spindles permit better homogenization and dispersion or, respectively, a greater product throughput.

The maximum number of planetary spindles installable between the main spindle and the roll cylinder depends on the diameter of the roll cylinder and on the diameter of the planetary spindles used. When using relatively large barrel diameters, as required for obtaining production-scale throughputs, and/or relatively small diameters for the planetary spindles, the roll cylinders can be equipped with a relatively large number of planetary spindles. For example, with a barrel diameter of D=70 mm, typically up to seven planetary spindles are used, whereas with a barrel diameter of D=200 mm ten, and a barrel diameter of D=400 mm 24 for example, planetary spindles can be used. However, these examples are in no way limiting to those skilled in the art. For example, if the diameter of the main spindle is smaller relative to a larger main spindle, the number of planetary spindles can be increased. Likewise, if the diameter of the main spindle is greater relative to a larger main spindle, the number of planetary spindles can be decreased.

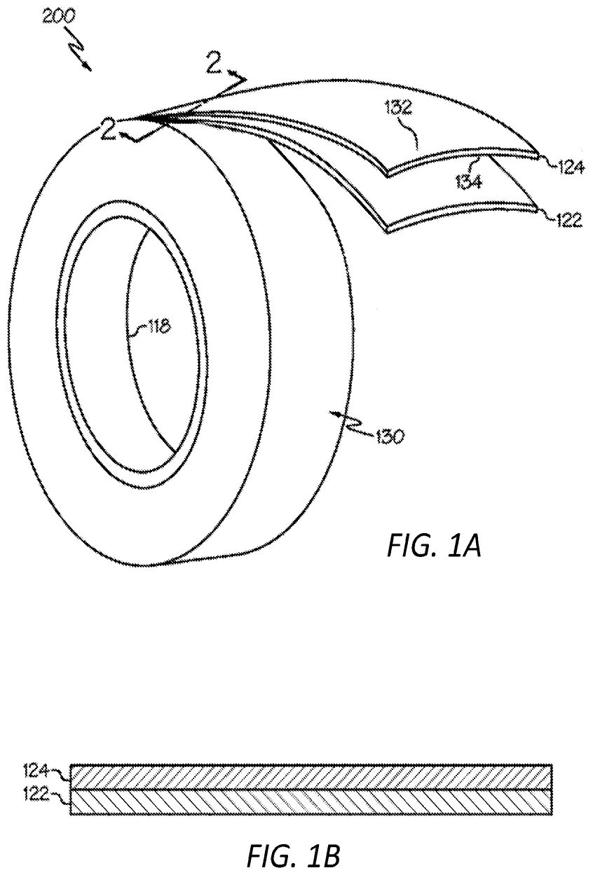

Turning now to the drawings, and referring initially to FIG. 1A, a roll 200 of tape 130 wound onto a core 118, the role of tape having essentially a paper backing 124 and a starch comprising reinforcement 122. Referring to FIGS. 1A and 1B for explanation, from top to bottom relative to the page, the tape 130 includes a paper backing 124. The paper backing 124 (also referred to as a substrate) has a first major (top) surface 132, a second major (bottom) surface 134, and a first side and a second side. As shown, applied to the bottom surface 134 of the backing 124 is the a starch comprising reinforcement 122. Starch comprising reinforcement 122 is configured to function as an adhesive, for example a water activated adhesive. For example, the starch comprising reinforcement 122 can be activated using an aqueous medium such as water or water and alcohol prior to use. In one example, the starch comprising reinforcement 122 is a film, web, scrim, or layer.

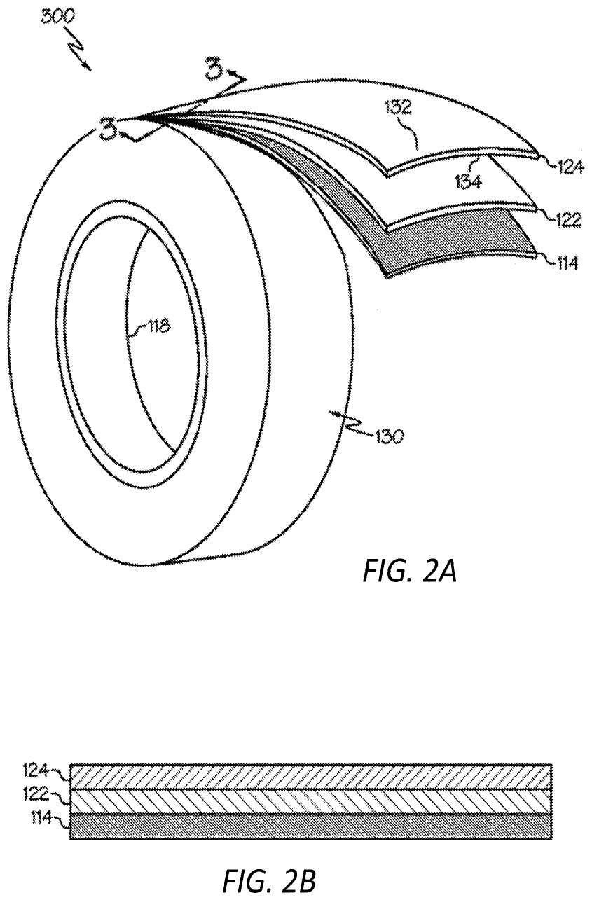

With reference to FIG. 2A, a roll 300 of tape 130 wound onto a core 118 is shown, the role of tape having essentially a paper backing 124 a starch comprising reinforcement 122 and an adhesive 114. Referring to FIGS. 2A and 2B for explanation, from top to bottom relative to the page, the tape 130 includes a paper backing 124. The paper backing 124 (also referred to as a substrate) has a first major (top) surface 132, a second major (bottom) surface 134, and a first side and a second side. As shown, a starch comprising reinforcement 122 is positioned adjacent to the paper backing 124, and an adhesive 114 is applied to the opposing surface of the starch comprising reinforcement 122. In one example, the adhesive 114 is water activated adhesive. In another example, the adhesive 114 is a pressure sensitive adhesive.

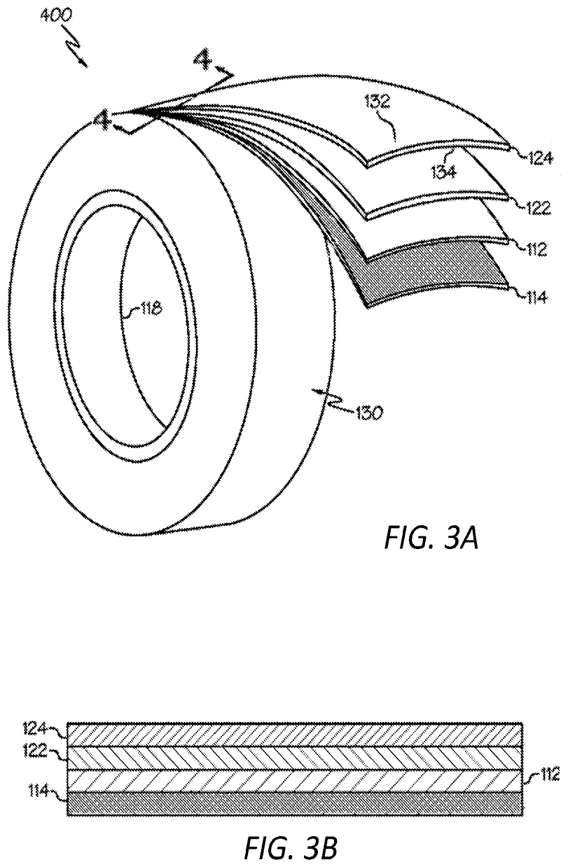

With reference to FIG. 3A, a roll 400 of tape 130 wound onto a core 118 the role of tape having essentially a paper backing 124, a starch comprising reinforcement 122, a paper layer 112 and an adhesive 114. Referring to FIGS. 3A and 3B for explanation, from top to bottom relative to the page, the tape 130 includes a paper backing 124. The paper backing 124 (also referred to as a substrate) has a first major (top) surface 132, a second major (bottom) surface 134, and a first side and a second side. As shown, a starch comprising reinforcement 122 is positioned adjacent to the paper backing 124. As shown in FIGS. 3A, 3B, additional paper layer 112 is positioned adjacent an opposing surface of the starch comprising reinforcement 122. Adhesive 114 is applied to an opposing surface of the paper layer 112. In one example, the adhesive 114 is water activated adhesive. In another example, the adhesive 114 is a pressure sensitive adhesive. In another example, the adhesive 114 is a repulpable pressure sensitive adhesive. In another example, the adhesive 114 is a heat-activated adhesive. In another example, the adhesive 114 is a repulpable heat-activated adhesive.

In one example, the backing 124 and starch comprising reinforcement 122 are extrusion laminated. In one example, the backing 124 and starch comprising reinforcement 122 are extrusion laminated without an additional material, e.g., one surface of the starch comprising reinforcement 122 is activated, e.g., with a state of water and laminated directly to the paper backing 124. In another example, the backing 124 and starch comprising reinforcement 122 are extrusion laminated together with a softened or molten layer therebetween that laminates the layers together, which once set, solidifies. The softened or molten layer can be extruded between the backing 124 and starch comprising reinforcement 122 or coextruded with the starch comprising reinforcement 122.

In one example, the backing 124 and starch comprising reinforcement 122 are adhesive laminated. In one example, the backing 124 and starch comprising reinforcement 122 are adhesive laminated without an adhesive, e.g., one surface of the starch comprising reinforcement 122 is activated, e.g., with a state of water and adhered directly to the paper backing 124. In another example, the backing 124 and starch comprising reinforcement 122 are adhesive laminated together with a layer or discontinuous pattern of adhesive therebetween that adheres the layers together. The adhesive can be extruded between the backing 124 and starch comprising reinforcement 122 or coextruded with the starch comprising reinforcement 122.

With reference to roll 300, in one example, the adhesive 114 and starch comprising reinforcement 122 are extrusion laminated. In one example, the adhesive 114 and starch comprising reinforcement 122 are extrusion laminated without an additional material, e.g., one surface of the starch comprising reinforcement 122 is activated, e.g., with a state of water and laminated directly to the adhesive 114. In another example, the adhesive 114 and starch comprising reinforcement 122 are extrusion laminated together with a softened or molten layer therebetween that laminates the layers together, which once set, solidifies. The softened or molten layer can be extruded between the adhesive 114 and starch comprising reinforcement 122 or coextruded with the starch comprising reinforcement 122.

In one example, the adhesive 114 and starch comprising reinforcement 122 are adhesive laminated. In one example, the adhesive 114 and starch comprising reinforcement 122 are adhesive laminated without an adhesive, e.g., one surface of the starch comprising reinforcement 122 is activated, e.g., with a state of water and adhered directly to the adhesive 114. In another example, the adhesive 114 and starch comprising reinforcement 122 are adhesive laminated together with a layer or discontinuous pattern of adhesive therebetween that adheres the layers together. The adhesive can be extruded between the adhesive 114 and starch comprising reinforcement 122 or coextruded with the starch comprising reinforcement 122.

With reference to roll 400, in one example, the backing 124 and starch comprising reinforcement 122 are extrusion laminated. In one example, the backing 124 and starch comprising reinforcement 122 are extrusion laminated without an additional material, e.g., one surface of the starch comprising reinforcement 122 is activated, e.g., with a state of water and laminated directly to the paper backing 124. As shown, roll 400 further comprises a paper layer 112 adjacent the opposing side of the starch comprising reinforcement 122. In one example, the paper layer 112 and starch comprising reinforcement 122 are extrusion laminated. In one example, the paper layer 112 and starch comprising reinforcement 122 are extrusion laminated without an additional material, e.g., one surface of the starch comprising reinforcement 122 is activated, e.g., with a state of water and laminated directly to the paper layer 112.

In one example, the paper backing 124, starch comprising reinforcement 122, and paper layer 112 are extrusion laminated together. In one example, the paper backing 124, starch comprising reinforcement 122, and paper layer 112 are extrusion laminated together without an additional material, e.g., both surfaces of the starch comprising reinforcement 122 are activated, e.g., with a state of water and laminated directly to the paper backing 124 and paper layer 112. Adhesive 114 is positioned adjacent the opposing surface of paper layer 112. In one example, adhesive 114 is extrusion laminated to paper layer 112. In another example, adhesive 114 is adhesive laminated to paper layer 112.

In one example, the paper backing 124, starch comprising reinforcement 122, and paper layer 112 are adhesive laminated. In one example, the paper backing 124, starch comprising reinforcement 122, and paper layer 112 are adhesive laminated without an adhesive, e.g., both surfaces of the starch comprising reinforcement 122 are activated, e.g., with a state of water and adhered directly to the paper backing 124 and paper layer 112. In another example, the paper backing 124, starch comprising reinforcement 122, and paper layer 112 are adhesive laminated together with a layer or discontinuous pattern of adhesive therebetween that adheres one or more or all of the layers together. The adhesive can be extruded between one or more of the paper backing 124, starch comprising reinforcement 122, and paper layer 112 or coextruded with the starch comprising reinforcement 122.

In one example, the adhesive 114 of roll 400 is extrusion or adhesive laminated directly to the paper layer 112. In another example, the adhesive 114 and paper layer 112 are adhesive laminated together with a layer or discontinuous pattern of adhesive therebetween that adheres the layers together. The adhesive can be extruded between the adhesive 114 and starch comprising reinforcement 122 or coextruded with the starch comprising reinforcement 122.

The aforementioned processing steps for rolls 200, 300, or 400 can be carried out continuously, semi-continuously, or in batches.

Optionally, applied to the top surface of the paper backing 124 is a release layer. In one example, the roll 200, 300, 400 is without a release layer.

Examples of the reinforcement starch include starches derived from cassava, corn, potato, sweet potato, sago, tapioca, sorghum, bean, bracken, lotus, Trapa japonica, wheat, rice, oat, arrowroot, pea, and the like. In one example, starch derived or modified from corn or cassava is used. In another example, starch derived or modified from high amylose corn is used.

The reinforcement starch may be a single substance, or may be a mixture of two or more starches, two or more modified starches, a modified starches and a non-modified starch, a cross-linked starch, a cross-linked starch combined with one or more modified starches or un-crosslinked starch. In one embodiment, the reinforcement starch is derived from corn, sorghum, wheat, sago, tapioca, legumes, barley, rice, dent and/or potatoes. In one embodiment, the reinforcement starch is derived from corn, sorghum, wheat, sago, tapioca, legumes, barley, rice, dent and/or potatoes. In one embodiment, the reinforcement starch is a blend of an unmodified starch and a modified starch, selected from corn, sorghum, wheat, sago, tapioca, legumes, barley, rice, dent, pea, and/or potatoes. In one embodiment, the reinforcement starch is a blend of two or more starches, independently selected from an unmodified starch, a modified starch, or crosslinked starch of corn, sorghum, wheat, sago, tapioca, legumes, barley, rice, dent, pea, and/or potatoes. In one embodiment, the reinforcement starch is a blend of two or more starches, independently selected from an unmodified starch, a modified starch, or crosslinked starch of corn, sorghum, wheat, sago, tapioca, legumes, barley, rice, dent, pea, and/or potatoes and one or more a synthetic starches.

In one example, the starch or modified starch as a content of amylopectin of 50% by mass or more, 55% by mass or more, 60% by mass or more, 70 % by mass or more, 80 by mass or more, 90 % by mass or more. In one example, the starch or modified starch as a content of amylose of 50% by mass or more, 55% by mass or more, 60% by mass or more, 70 % by mass or more, 80 % by mass or more, 90 % by mass or more.

Independently, with regard to either the starch, modified starch or synthetic starch an amylose to amylopectin weight ratio between 40:60 to 0:100 can be employed. A blend of starches with a combined amylopectin weight ratio between 40:60 to 0:100 can be employed. A modified starch having an amylose to amylopectin weight ratio between 40:60 to 0:100, or a blend of modified starches with a combined amylose to amylopectin weight ratio between 40:60 to 0:100 can be employed. A combination of a first starch having an amylose to amylopectin weight ratio between 40:60 to 0:100 and a second starch having an amylose to amylopectin weight ratio between 40:60 to 0:100, where at least one of the first starch and the second starch, independently, is unmodified, modified, synthetic, or crosslinked can be employed.

Examples of modified starch include alkyl etherized starches such as methyl etherized starch, carboxyalkyl etherized starches such as carboxymethyl etherized starch, and hydroxyalkyl etherized starches such as etherized starch having a hydroxyalkyl group having 2 to 6 carbon atoms, and the like. Alternatively, allyl etherized starches and the like can also be used as a modified starch.

Additional examples of modified starches include esterified starches having a structural unit derived from carboxylic acid, such as esterified starch having a structural unit derived from acetic acid; esterified starches having a structural unit derived from dicarboxylic anhydride, such as esterified starch having a structural unit derived from maleic anhydride, esterified starch having a structural unit derived from phthalic anhydride, and esterified starch having a structural unit derived from octenylsuccinic anhydride; esterified starches having a structural unit derived from oxo acid, such as nitric acid esterified starch, phosphoric acid esterified starch, and urea-phosphoric acid esterified starch. Other examples thereof include xanthogenic acid esterified starch, acetoacetic acid esterified starch, and the like. Alkoxyl silane/siloxane TEOS, etc

Examples of crosslinked starch include formaldehyde-crosslinked starch, epichlorhydrin-crosslinked starch, phosphoric acid-crosslinked starch, acrolein-crosslinked starch, sodium tetraborate crosslinked starch, and the like.

In one example, the starch or modified starch film, web, scrim, or layer in a dry state comprises a water content of about 10 to 25% by mass, or from about 20-25% by mass, as determined by ASTM E 203 or ISO 760.

In one example, the adhesive 114 is any conventional adhesive or hereinafter developed adhesive suitable for box sealing or carton sealing tapes (also referred to as packaging tapes). In one example, the adhesive 114 can be a water activated adhesive. In one example, the adhesive 114 can be a water activated adhesive used together with an amorphous polyolefin adhesive, a natural rubber adhesive, a poly(meth)acrylate adhesive and the like. In one example, the adhesive 114 can be mixed or blended with an amorphous polyolefin adhesive, a natural rubber adhesive, a poly(meth)acrylate adhesive and the like.

In one example, the adhesive 114 can be layered on a layer, or between layers of an amorphous polyolefin adhesive, a natural rubber adhesive, a poly(meth)acrylate adhesive and the like, e.g., a layer/film or pattern of pressure sensitive adhesive and a layer/film or pattern of water-activated adhesive, etc. In one embodiment, the adhesive 114 is a starch comprising adhesive from corn, sorghum, wheat, sago, tapioca, legumes, barley, rice, dent, pea, and/or potatoes. In one embodiment, the adhesive 114 is a crosslinked starch comprising adhesive from corn, sorghum, wheat, sago, tapioca, legumes, barley, rice, dent and/or potatoes. In one embodiment, the adhesive 114 is a blend of two or more, independently selected unmodified starch, modified starch, and crosslinked starch comprising adhesive, independently selected from corn, sorghum, wheat, sago, tapioca, legumes, barley, rice, dent, pea, and/or potatoes. In one embodiment, the adhesive 114 is a blend of two or more, independently selected unmodified starch, modified starch, and crosslinked starch comprising adhesive, independently selected from corn, sorghum, wheat, sago, tapioca, legumes, barley, rice, dent, pea, and/or potatoes and one or more synthetic starches and non-starch comprising adhesive. The adhesive 114 can be the same or different composition as that of the starch comprising reinforcement 122.

In another embodiment, the adhesive 114 may be a polyvinyl alcohol, polyvinyl alcohol copolymer, polyvinyl alcohol blend remoistenable adhesive. In another embodiment, the adhesive 114 may be a blend of one or more polyvinyl alcohol, polyvinyl alcohol copolymer, polyvinyl alcohol blend remoistenable adhesives and any of the aforementioned starch adhesives.

A continuous method of manufacturing the starch comprising reinforcement 122 tapes includes providing a paper tape comprising a paper backing having an adhesive defining a bottom major surface thereof, and opposite the adhesive of the paper backing, a starch comprising reinforcement 122 reinforcement structure. The film reinforcement structure provides a strength to the water activated paper tape essentially equivalent to or greater than conventional reinforcements such as scrims, oriented films, yarns or fibers of PVC, glass, carbon, PET, high molecular weight polyethylene, polyamide, and other engineering thermoplastics and the like. The film reinforcement structure provides a strength to the water activated paper tape essentially equivalent to or greater than conventional reinforcements that pass ISTA 3A and ISTA 6A, i.e. keeping a box/package closed through transit without the tape tearing or breaking, thus eliminating or reducing the need for other types of reinforcement. The film reinforcement structure presently disclosed can be used in combination with any of the above conventional reinforcements.

In one example, the starch comprising reinforcement 122 is contiguous to the paper backing 124 and includes coextruding the starch comprising reinforcement 122 directly onto the paper backing. The method may also include reducing the temperature of the starch comprising reinforcement 122 after its extruding and before contact with the paper backing 124.

The method may also include winding the tape onto a roll and slitting the rolled tape into a plurality of rolls of film laminated water-activation tape.

In another example, the continuous method of manufacturing a film laminated tape may also include providing the paper backing 124 and applying adhesive to a bottom major surface thereof before coextruding the outermost polyolefin film and lamination layers onto the paper backing.

The tapes described above provide for the elimination of filament or yarn scrim reinforcement and may only require one layer of paper. This results in a tape product with uniform puncture and tear properties at a similar or lower total cost to commercially available carton sealing tapes today as well as producing a thinner tape that will provide more length for a given barrel diameter, requiring fewer roll changes on application equipment.

The tape and/or starch comprising film composition of the present disclosure can further comprise clay. Examples of the clay include synthetic and natural layered silicate clays such as montmorillonite, bentonite, beidellite, mica, hectorite, saponite, nontronite, sauconite, vermiculite, ledikite, magadite, kenyaite, stevensite, volkonskoite, and a mixture thereof.

In one example, the content of the clay in the resin composition is between 0.1 to 5% by mass, between 0.1 to 3% by mass, and further between 0.5 to 2% by mass. When the resin composition comprises the clay in an amount within the above range, there is a tendency that the transparency, the flexibility, the tensile strength, the impact resistance and/or the tensile properties are easily improved.

In one example, the starch composition can comprise additives such as fillers, processing stabilizers, weather resistance stabilizers, coloring agents, ultraviolet absorbing agents, light stabilizers, antioxidants, antistatic agents, flame-retardants, plasticizers, other impact modifiers, lubricants, perfumes, antifoaming agents, deodorants, bulking agents, releasing agents, mold releasing agents, reinforcing agents, crosslinking agents, fungicides, biocides, humectants, antiseptics, and crystallization rate retardants as necessary, in such a range that the effect of the present disclosure is not hindered.

The starch composition may be produced in the form of a pellet or a film. As a pellet, the starch composition can be stored and/or presented for extrusion into a film or extrusion laminated. As a film, the starch composition can be used in a multilayer laminate comprising at least one layer comprising the starch comprising film. Additionally, the starch film is excellent in strength and biodegradable, at least partially or essentially water-soluble and repulpable so that it can be suitably used in sustainable packaging films, tape, or with packaging materials.

The present tape and composition of the present disclosure can be produced by a production method comprising continuously mixing an amount of starch and an amount of water, optionally with other material, while heating in a low shear mixer, e.g., a planetary rotary extruder, and obtaining a extrudate; continuous extruding the extrudate; cooling the melt to form a repulpable reinforcement film or pellet; contacting the film (or reprocessing the pellet to form a film) to the second major surface of the repulpable paper backing; and applying an adhesive composition adjacent the repulpable reinforcement.

In one aspect, the method further comprises providing a tape.

In one aspect, alone or in combination with any one of the previous aspects, the contacting the film to the second major surface of the repulpable backing is continuous.

In another example, a process for producing a starch film composition is provided, comprising continuously metering into a low shear extrusion equipment a starch film composition comprising a starch, modified starch, thermoplastic starch, or combination, water, and a repulpable material; continuously mixing the composition in a compounding section of the low shear extrusion equipment In one aspect, alone or in combination with any one of the previous aspects, the compounding section comprises a main spindle surrounded by and intermeshed with a plurality of planetary spindles wherein at least one of the planetary spindles is a double transversal mixing spindle comprising a plurality of back-cut helical flights; and continuously discharging the starch film composition from the extruder.

An exemplary low shear extrusion equipment in accordance with the present disclosure is illustrated and generally designated by the reference 10. It will be appreciated that the low shear extrusion equipment system 10 is illustrated in diagrammatic form in order to explain its operation in easily understandable manner. However, in actual practice, the shape and size of the system 10 might be substantially different from that illustrated and yet still be within the scope of the claims set forth herein.

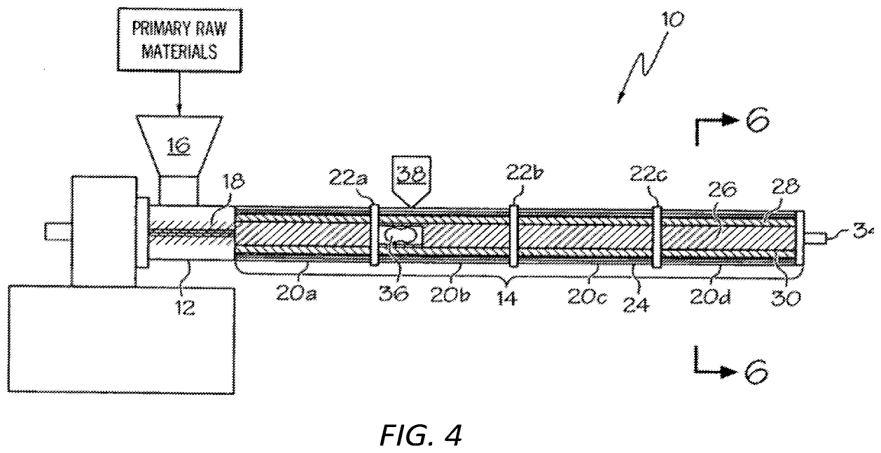

The low shear extrusion equipment system 10 includes a feeding section 12 and a compounding section 14. The primary adhesive raw materials are added into the feed throat 16 and metered onto the conveying screw 18 of the filling section 12. As used herein, the term “primary raw materials” refers to those materials of the adhesive formulation added into the feed section 12 of the low shear extrusion equipment 10. Primary raw materials may include, but are not limited to, elastomers, resins, extenders, activators, anti-degradents, and crosslinking agents. The screw 18 conveys the primary raw materials into the compounding section 14. The compounding section 14, as illustrated in FIG. 4, includes four planetary roller barrel sections 20a, 20b, 20c and 20d separated by dosing rings 22a, 22b and 22c. Each roller barrel section 20 includes a 45° helical toothed cylinder 24, a 45° helical toothed main spindle 26 and a plurality of 45° helical toothed planetary spindles 28, 30. The helical gearing can have any suitable angle, for example, an angle of 10 to 60°, more particularly somewhat greater than 20° may be useful. In accordance with the certain aspects of the present disclosure, at least one of the roller barrel sections 20 includes a double transversal planetary spindle 28. The present disclosure is not limited to the use of double transversal planetary spindles. Other spindle configurations that provide the desired levels of mixing can also be used.

The maximum number of planetary spindles 28, 30 is a function of the diameter of the main spindle 26 and the helical toothed cylinder 24. The planetary spindles 28, 30 can exhibit many different tooth geometries, e.g., full helical flights (Planetspindel) 30, double transversal helical flights (also known as back-cut spindles or Noppenspindel) 28, or zoned helical flights (Igelspindel), etc. The number of planetary spindles chosen and their geometries (e.g., open vs. full flight) can be manipulated in such a way as to influence the dynamic discharging effect of each roller barrel section 20 and the discharging differential between sections. Additionally, the gap between the dosing ring 22 and the main spindle 26 can be changed to vary the dynamic discharging effect of each barrel section 20 and the discharging differential between the barrel sections 20.

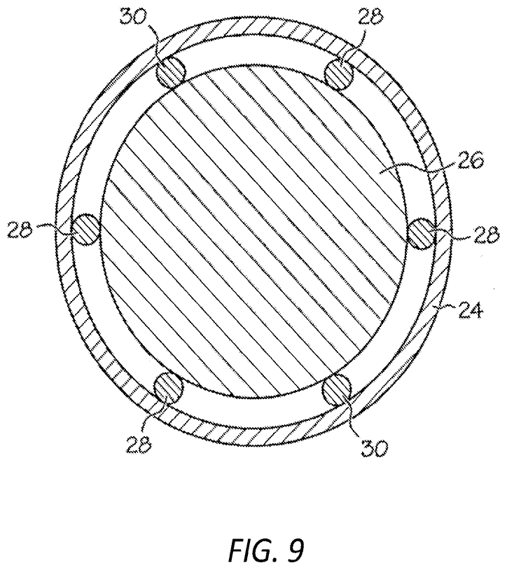

A standard planetary spindle 30 is represented by a cylinder in which grooves or flights have been cut at 45° angles to the spindle axis, the same angle as the main spindle flights. The planetary spindles ride in the main spindle flights and this exemplary design shown in FIG. 4 and FIG. 9 yields identical surface speeds of the planetary spindles 28, 30 and the main spindle 26. There is a gap between the main and planetary spindles which is filled with process material and the net result is that near zero-shear distributive and dispersive mixing can occur between the main spindle 26, the planetary spindles 28, 30, and the barrel wall 24. Other arrangements of spindles and flights can be used. For example, spindels from Rust-Mitschke-Entex (Bochum, DE) can be used, including standard, Noppen, Igel, Transport, Kombi spindels.

Another net result of the 45° angle cut into the planetary and main spindles is a positive pressure, a forwarding motion imparted on the process material. A variation which yields less pressure, more slippage, less forwarding motion, longer residence time and hence greater mixing is the use of or double transversal spindles 28 (also known as noppenspindles or back-cut spindles).

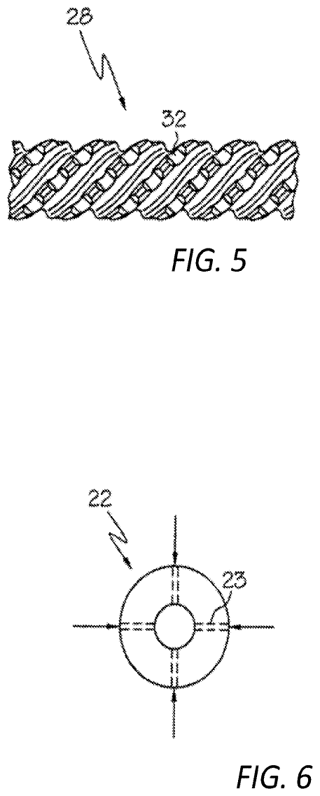

Double transversal planetary spindles 28 are spindles having openings in the flights that permit material to pass between the wall of the barrel 24 and the main spindle 26 and slow the rate with which material passes through the low shear extrusion equipment system 10. One example of a double transversal spindle 28 is a so-called porcupine spindle. A particular example of a double transversal spindle 28 is shown in detail in FIG. 5, back cut openings 32 increase residence time and improve mixing. The design of a double transversal spindle 28 is a variation of the standard planetary spindle, with the addition of channels cut into the 45° angled flights. The angle of these back cut channels can range from about 45-135° relative to the spindle flights, more particularly from about 75-105°, and in accordance with certain aspects of the disclosure the back cut channels may be at an angle of about 90°. The number and depth of these channels may also be varied and can be defined in more simplistic terms by the following: [(total channel area cut into the spindle flights/total area of spindle flights)×100%]. This value may range from about 10-90%, more particularly from about 40-60%, and in certain embodiments of the disclosure the value may be about 50%. Low shear extrusion equipment having double transversal spindles 28 are commercially available from Rust-Mitschke-Entex. By adjusting the number of full flight 30 and open or double transversal spindles 28, the rate with which material passes through the low shear extrusion equipment and hence the amount of mastication that is done on the material can be controlled.

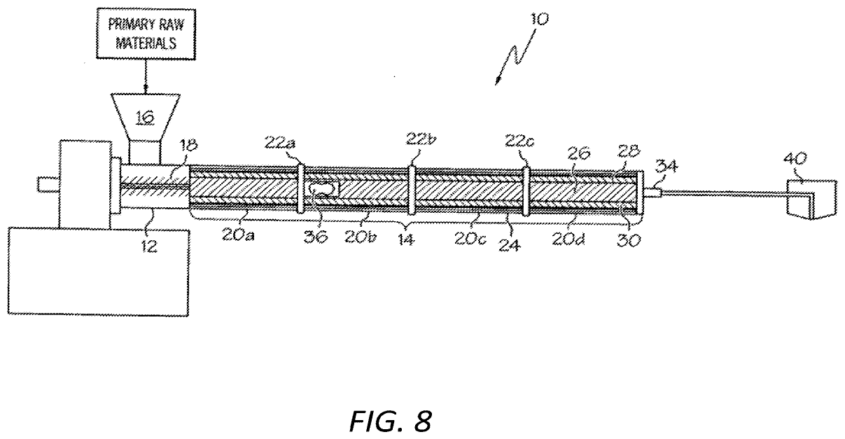

Conventional low shear extrusion equipment contain at least 3 and can contain up to 24 spindles depending on the diameter of the cylinder and process design. Of course, one of skill in the art would realize that a greater number of planetary spindles could be used depending on the specific dimensions and construction of the extruder. In one embodiment of the disclosure, a low shear extrusion equipment 10 having a 70 mm diameter cylinder having 6 spindles 28, 30 is used. In accordance with certain aspects of the disclosure, the double transversal spindles 28 account for more than 20%, more particularly more than 50%, of the number of planetary spindles 28, 30 in the low shear extrusion equipment 10. FIG. 8 shows a cross-section for a planetary extruder in accordance with a particular embodiment of the disclosure that includes four (4) double transversal planetary spindles 28 and two (2) full flight spindles 30. In one example 75% full flight spindles and 25% back-cut, or Noppenspindlen is used for processing the starch composition of the present disclosure.

The rotation of the main spindle 26 causes the planetary spindles 28, 30 to be set in rotational movement, as a result of the helical gearing of the main spindle 26 interacting with the helical gearing of the planetary spindles 28, 30.

The planetary spindles 28, 30 also mesh with the internal gearing of the cylinder section 24. The helical gearing of the main spindle 26, the planetary spindles 28, 30 and the cylinder section 24 conveys the raw materials to be compounded in the direction of the discharge orifice 34.

The term “secondary raw materials” as used herein refers to raw materials or solvents introduced into the compounding section 14 of the low shear extrusion equipment 10. Secondary liquid materials, such as liquids, molten resins, oils, solvents, plasticizers, etc., can be introduced into the compounding section 14 via injection nozzles (not shown) through the dosing ring 22 assemblies. As shown in FIG. 6, the dosing rings 22 include radially extending bores 23 that allow for metered addition of liquids to the compounding section 14. In accordance with one embodiment of the disclosure, the process involves the feeding of solvent into the compounding section 14 of the low shear extrusion equipment 10 via the dosing rings 22.

Secondary solid raw materials can be added to the compounding section 14 through a side feeder 36 or twin screw dosing units 38. The twin screw dosing units 38 are typically positioned perpendicular to the axis of the compounding section 14 and are typically located near the beginning of the compounding section directly adjacent to the dosing ring 22a. The twin screw dosing units 38 can be employed to introduce solid components such as reinforcing agents, thermoplastic elastomers, resins, extenders, activators, anti-degradents, crosslinkers, etc., to the individual roller barrel sections 20.

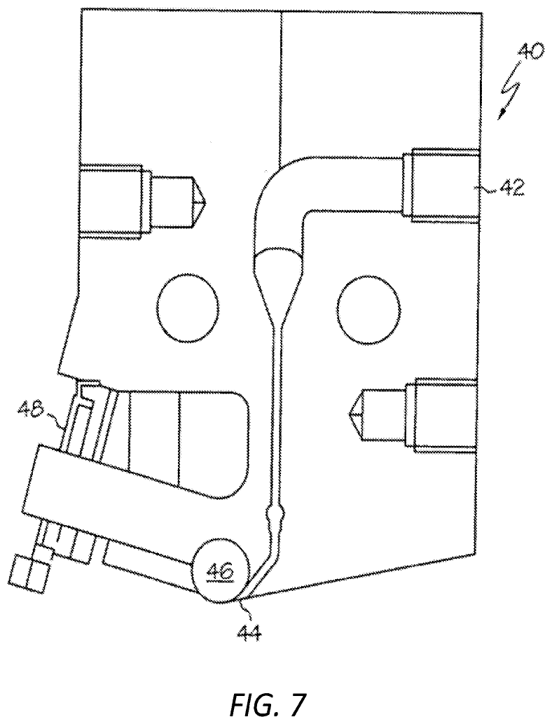

Another embodiment of the disclosure involves coating the starch film composition on the paper backing using any of a variety of coating techniques including, but not limited to, slot-die coating, roll-over-roll coating, calender coating, reverse roll and knife-over-roll coating. In accordance with certain embodiments of the present disclosure, the adhesive composition is applied to the starch film and/or any intervening paper material using a slot-die applicator unit. Particularly useful methods for applying the adhesive composition to the web-form material include slot-die coating using a rotating lip die or a fixed lip contact die. One particular slot die unit that can be used is a rotating lip die having a spindle that trails the die lip. One example of such a die is commercially available from SIMPLAS and is shown in FIG. 7. Rotating lip die 40 includes an inlet 42 for receiving the adhesive composition from the extruder 10. As shown in FIG. 8, the starch composition can be continuously conveyed from the planetary extruder 10 to the rotating lip die 40 applicator to be applied to a web-form material through slot 44. The rotating lip die applicator 40 further includes a rotating spindle 46 at the trailing edge of the die lip that improves coating properties of the applied adhesive. Adjustable bolts 48 on the rotating lip die applicator 40 enable the operator to easily adjust the lip opening and control the adhesive coating thickness.

In accordance with another aspect of the present disclosure, the starch comprising composition may be crosslinked. More specifically the starch comprising composition may be crosslinked thermally, chemically, e.g., with azides, epichlorhydrin, formaldehyde, phosphoric acid, acrolein, sodium tetraborate, epoxides, anhydrides, and/or with the aid of electron beams or UV rays by means of ionizing radiation, such as electron beams, for example, so that the resultant starch comprising composition provides a shear-resistant and temperature-stable film, web, scrim or layer.

Additional advantages of certain embodiments of the new disclosure/method include; 1) purposeful, effective, and efficient compounding, e.g., with minimal shear of the starch comprising compositions, 2) the introduction of various additional materials into the compounding section, 3) the introduction of solvent or a state of water into the compounding section, and 4) the use of pelletizing, slot-die, annular die coating technology to achieve an web, film, or layer material.

The compounding of the presently disclosed starch or modified starch with repulpable material is accomplished as the starch is forced with the single-screw from the feeding section between the dosing ring and the main spindles into the compounding section, where it is mixed and subsequently compounded. The degree of shear and/or chain scission of the starch can be minimized by selecting the appropriate combination of planetary spindle geometry and the number of planetary spindles employed. Reduction of shear of the starch or modified starch translates into more efficient compounding of the starch with the repulpable materials as well as other solid and liquid materials, and yields the potential for a minimization of molecular weight reduction.

Thus, in one example, the starch, alone or in composition with the repulpable materials as well as other solid and liquid materials is compounded such that the average or number average Mw is reduced to less than 5%, less than 10%, less than 20%, less than 30%, less than 24%, less than 50%, as measured by GPC. The reduction is in reference to the initial molecular weight of the starch as it is being introduced into the low shear extrusion equipment. As such, the initial molecular weight may already have been reduced as a result of preprocessing of the starch as compared to the molecular weight for the unprocessed starch. Therefore, the reduction in molecular weight referred to herein is based on the reduction in molecular weight obtained by processing on the low shear extrusion equipment. The reduction in molecular weight as described herein is calculated by Formula 1:

% Reduction=(Mw(initial)−Mw(final))/Mw(initial)×100 (I)

The introduction of various additional materials into the compounding sections has several advantages. First, all such additional materials do not have to be introduced all at once in the feeding section of the low shear extrusion equipment, i.e., they can be dosed in one or more of the roller barrel sections of the compounding section. This gives the starch more time to be compounded prior to the addition the repulpable materials as well as other solid and liquid materials and increases the mixing efficiency of the low shear extrusion equipment. The addition of the repulpable materials as well as other solid and liquid materials further enhances mixing efficiency, tending to act as a lubricant and improving mixing efficiency. Additionally, the repulpable materials as well as other solid and liquid materials may have a specific heat capacities that provides the ability to act as a heat sink, i.e. take heat away from the process, thereby minimizing the temperature of the melt during the compounding process.

In the first process step, a composition comprising the starch and repulpable materials as well as other solid and liquid materials and the known adjuvants, such as extenders, antioxidants, activators, colorants, ageing inhibitors, plasticizers and tackifier resins, is produced in a low shear extrusion equipment, the composition having a final temperature of less than 200° C., of less than about 150° C., 140° C., 130° C., 120° C., 110° C., for example, between about 25° C. and 175° C. The overall residence time of the composition in the low shear extrusion equipment will typically not exceed about three minutes, five minutes, ten minutes or more.

In accordance with certain aspects of the disclosure, the starch film exiting from the extruder can be used immediately as a web-form material or can be pelletized for film processing and casting at a later time. This can be done in a particularly effective and advantageous manner using a slot-die applicator unit, especially using a rotating lip slot-die applicator unit.

In one example, the presently disclosed starch-based reinforcement or tape comprising the starch-based reinforcement is at least 60% up to about 99% repulpable. In one example, the presently disclosed starch-based reinforcement or tape comprising the starch-based reinforcement is at least 65%, 70%, 75%, 80%, 85%, 90%, 95%, 96%, 97%, 98%, or more than 99% repulpable. In one example, the presently disclosed starch-based reinforcement or tape comprising the starch-based reinforcement is at least 60% up to about 99% repulpable per the 2013 Fibre Box Association Voluntary Standard for Repulping and Recycling Corrugated Fiberboard Treated to Improve Its Performance in the Presence of Water and Water Vapor (“FBA method”).

While certain embodiments of the present disclosure have been illustrated with reference to specific combinations of elements, various other combinations may also be provided without departing from the teachings of the present disclosure. Thus, the present disclosure should not be construed as being limited to the particular exemplary embodiments described herein and illustrated in the Figures, but may also encompass combinations of elements of the various illustrated embodiments and aspects thereof.

1-20. (canceled)

21. A tape comprising:
a repulpable backing having a first major surface and an opposing second major surface;
a repulpable reinforcement adjacent the second major surface; and
an adhesive layer adjacent the repulpable reinforcement.

22. The tape of claim 21, wherein the repulpable backing comprises essentially cellulose, unmodified starch, modified starch, synthetic starch, crosslinked starch, thermoplastic starch, polyvinyl alcohol or polyvinyl alcohol copolymer and salts thereof, polyethyleneimines, polyvinyl pyrrolidones, polyalkylene oxides, polyhydroxyalkanoates, polyacrylamides, cellulose ethers, cellulose esters, cellulose amides, polyvinyl acetates, polyamides, poly(meth)acrylic acid, poly(meth)acrylates and salts thereof, gelatines, methylcelluloses, carboxymethylcelluloses and salts thereof, ethylcelluloses, hydroxyethyl celluloses, hydroxypropyl methylcelluloses, dextrins, maltodextrins, guar gum, gum Acacia, xanthan gum, carrageenan, copolymers thereof, blends thereof, and combinations thereof.

23. The tape of claim 22, wherein the repulpable backing is paper, or Kraft paper.

24. The tape of claim 21, wherein the repulpable reinforcement is directly adjacent to the repulpable backing.

25. The tape of claim 21, wherein the repulpable backing is extrusion laminated or adhesion laminated to the repulpable reinforcement, or the repulpable backing is adhesion laminated to the repulpable reinforcement without adhesive.

26. The tape of claim 21, wherein the repulpable reinforcement is film, web, or scrim comprising an unmodified starch, a modified starch, a synthetic starch, a thermoplastic starch, a crosslinked starch, or mixture of two or more thereof.

27. The tape of claim 21, wherein the repulpable reinforcement is at least 90 weight percent hot water soluble or repulpable under pulping conditions.

28. The tape of claim 21, wherein the repulpable reinforcement comprises an unmodified starch, a modified starch, a synthetic starch, a thermoplastic starch, or a crosslinked starch derived from cassava, corn, potato, sweet potato, sago, tapioca, sorghum, bean, bracken, lotus, Trapa japonica, wheat, rice, oat, arrowroot, dent, or pea.

29. The tape of claim 21, wherein the repulpable reinforcement comprises an unmodified starch, a modified starch, a synthetic starch, a thermoplastic starch, or a crosslinked starch derived from glutinous rice, waxy potato starch, and waxy corn.

30. The tape of claim 21, wherein the repulpable reinforcement is an extruded web, film, or layer.

31. The tape of claim 21, wherein the repulpable reinforcement comprises a starch with a combined weight ratio of amylose to amylopectin between 40:60 to 0:100, a modified starch with a combined weight ratio of amylose to amylopectin between 40:60 to 0:100, a synthetic starch with a combined weight ratio of amylose to amylopectin between 40:60 to 0:100, or a thermoplastic starch with a combined weight ratio of amylose to amylopectin between 40:60 to 0:100.

32. The tape of claim 21, wherein the repulpable reinforcement comprises a blend of starches with a combined weight ratio of amylose to amylopectin between 40:60 to 0:100, wherein the blend of starches comprises an unmodified starch, a modified starch, a synthetic starch, a thermoplastic starch, or a combination thereof.

33. The tape of claim 21, wherein the repulpable reinforcement comprises a blend of starches comprises a combination of a first starch having an amylose to amylopectin weight ratio between 40:60 to 0:100 and a second starch having an amylose to amylopectin weight ratio between 40:60 to 0:100, where at least one of the first starch and the second starch, independently, is unmodified, modified, synthetic, or crosslinked.

34. The tape of claim 21, wherein the repulpable reinforcement comprises starch or a modified starch in combination with polyvinyl alcohol or polyvinyl alcohol copolymer.

35. The tape of claim 21, wherein the adhesive layer is a water-activated adhesive.

36. The tape of claim 35, wherein the water-activated adhesive is a polyvinyl acetate emulsion adhesive, a poly ethylene vinyl acetate adhesive, a poly(meth)acrylic or poly(meth)acrylic emulsion adhesive, a starched-based adhesive, a repulpable pressure sensitive adhesive or combinations or laminates thereof.

37. The tape of claim 21, wherein the tape is at least 80, at least 85, or at least 90 weight percent hot water soluble or repulpable under pulping conditions.

38. A film comprising:
a starch; and
an amount of repulpable material,
wherein the repulpable material is polyvinyl alcohol or polyvinyl alcohol copolymer and salts thereof, polyethyleneimines, polyvinyl pyrrolidones, polyalkylene oxides, polyhydroxyalkanoates, polyacrylamides, cellulose ethers, cellulose esters, cellulose amides, polyvinyl acetates, polyamides, gelatines, poly (meth)acrylic acid, poly(meth)acrylates and salts thereof, methylcelluloses, carboxymethylcelluloses and salts thereof, ethylcelluloses, hydroxyethyl celluloses, hydroxypropyl methylcelluloses, microfibrillated celluloses, modified microfibrillated celluloses, dextrins, maltodextrins, guar gum, gum Acacia, gum Arabic, xanthan gum, carrageenan, algin, Locust Bean, gellan, copolymers thereof, blends thereof, and combinations thereof.

39. The film of claim 38, wherein the starch present in the film is an alkyl etherized starch, carboxyalkyl etherized starch, hydroxyalkyl etherized starch having a hydroxyalkyl group having 2 to 6 carbon atoms, a thermoplastic starch, a synthetic starch or is derived from cassava, corn, potato, sweet potato, sago, tapioca, sorghum, bean, bracken, lotus, Trapa japonica, wheat, rice, oat, arrowroot, dent, or pea.

40. The film of a claim 38, wherein the starch comprises an amylose to amylopectin weight ratio between 40:60 to 0:100, a blend of starches with a combined weight ratio of amylose to amylopectin between 40:60 to 0:100, a modified starch with a combined weight ratio of amylose to amylopectin between 40:60 to 0:100, a blend of modified starches with a combined weight ratio of amylose to amylopectin between 40:60 to 0:100, a combination of a first starch having an amylose to amylopectin weight ratio between 40:60 to 0:100 and a second starch having an amylose to amylopectin weight ratio between 40:60 to 0:100, where at least one of the first starch and the second starch, independently, is unmodified, modified, thermoplastic, synthetic, or crosslinked.
